(19) United States
(12) Patent Application Publication
(10) Pub. No.: US 2005/0230375 A1
(43) Pub. Date: Oct. 20, 2005

(54) Thermal developing apparatus

(75) Inventors: Masaya Shimoji, Tokyo (JP); Youji Yamamichi, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: KONICA MINOLTA MEDICAL & GRAPHIC, INC., Tokyo (JP)

(21) Appl. No.: 11/086,012

(22) Filed: Mar. 21, 2005

(30) Foreign Application Priority Data
Mar. 31, 2004 (JP) JP2004-104253

(51) Int. Cl. H05B 1/00

(52) U.S. Cl. 219/216

(57) ABSTRACT

A thermal developing apparatus comprises a thermal developing device for heating and visualizing a thermal developing film on which a latent image is formed while the thermal developing film is conveyed, the thermal developing device comprising, a heating device for heating the thermal developing film, a conveyance device for conveying the thermal developing film to be heated, a driving device for driving the conveyance device, a temperature detecting device for detecting a temperature of the heating device, and a controller for controlling the driving device so as to limit driving of the driving device until a detected temperature of the heating device reaches to a predetermined temperature.

This application is claimed priority from Japanese Patent Application No. 2004-104253 filed on Mar. 31, 2004, which is incorporated hereinto by reference.

### FIELD OF THE INVENTION

The present invention relates to a thermal developing apparatus for developing and visualizing a thermal developing film on which a latent image is formed while the film is conveyed and heated.

### BACKGROUND OF THE INVENTION

A medical imager (a thermal developing apparatus) employing a thermal developing process for thermally developing a thermal developing film, on which a latent image is formed by heating is known. In the imager, when a system employing a heating drum and a plurality of opposed rollers for heating and conveying a thermal developing film (hereinafter it will be simply called a film) as the film is sandwiched by the heating drum and the plurality of opposed rollers as disclosed in Japanese patent application Open to Public No. H10-500497, organic acid and higher fatty acid contained in the thermal developing film volatize from a film and volatized organic acid coheres and adheres on the surface of heating drum and opposed rollers as a film process proceeds.

When executing the thermal developing process described above, cutting dross and emulsion flakes from film edges (a leading edge, a rear edged and side edges) also adhere and cohere on the heating drum and the opposed rollers. And there is a case that organic acid and higher fatty acid volatized as a film heating process proceeds, cohere and adhere on substances such as the adhesive cutting dross and emulsion flakes as cores and result in foreign matter growth due to temperature down when the apparatus comes to a stop.

In the case that a system in which a thermal developing film is heated while conveyed by a conveyance roller (drum) on which a fixed plate heater is provided (refer to the specification of U.S. Pat. No. 4,518,845), organic acid and higher fatty acid contained in a thermal developing film are volatized by heat, and adhere onto the conveyance roller and the fixed plate heater. As a result, there are cases where these organic acid and higher fatty acid grow up into foreign matters due to the fact that they adhere on cohesive substances of the cutting dross and the emulsion flakes.

For example, when the structure of the heating conveyer of the thermal developing apparatus including a heating drum having a smooth surface of fluorine resin having a thickness of 30-60 μm provided on an elastic layer of silicon rubber structured on the surface of a sleeve including a heater therein, the heating drum starts rotating while the foreign matters of higher fatty acid, etc. adhered and grown on the surface of the heating drum and opposed rollers are hard and the opposed rollers contact the surface of the drum, when driving the heating drum and the opposed rollers at the time warm-up operation starts. Accordingly, there were cases where the surface of the smooth layer of the heating drum was damaged and got hitting marks having a concave shape by the cohesive substances when the substances had relatively sharp edges or a condition of the adherences of foreign matters.

Further, there were cases as described in Japanese Patent Application Open to Public No. H11-65073 where in a thermal developing apparatus having a harmful substance removing device as a cleaning means, for example, when the dust removing device is a cleaning web or a roller type, due to the hard substances, the cleaning web or the roller does not fully contact the surface of the drum.

### SUMMARY OF THE INVENTION

An object of the present invention is to provide a thermal developing apparatus for preventing foreign matters from damaging a heating drum and a cleaning device when. starting the operation of the thermal developing apparatus, which are generated and grown based on cutting dross and emulsion flakes from an adjacent portion of a thermal developing film cutting surfaces, which are adhered and solidified on the opposed roller and the fixed plate heater, when conducting a thermal developing process, and to solve the problems of prior art described above.

In accordance with one aspect of the present invention, a thermal developing apparatus comprises a heating device for heating a thermal developing film, a conveyance device for conveying the thermal developing film to be heated, a driving device for driving the conveyance device, a thermal developing device for heating and visualizing the thermal developing film on which a latent image is formed while the film is conveyed, a temperature detecting device for detecting a temperature of the heating device, and a controller for controlling the driving device so as to limit driving of the driving device until a detected temperature of the heating device reaches to a predetermined temperature.

According to the thermal developing apparatus, even thought organic acid and higher fatty acid volatized from a thermal developing film, as the film processing proceeds, cohere and adhere on cohesive substances of cutting dross from film edges and emulsion flakes which have adhered and cohered onto a heating device, since driving of a driving device is limited until the temperature of the heating device reaches to a predetermined temperature and the conveyer is driven after the temperature of the heating device reaches to the predetermined temperature and the foreign substances become soft, it can be protected that the surface of the heating device is damage by foreign matter when starting up the apparatus.

In the thermal developing apparatus described above, the thermal developing device is structured so that a plurality of opposed rollers is arranged so as to push the thermal developing film toward the heating device. In this case, since the temperature of the heating device reaches to the predetermined temperature, a conveyer is driven after foreign substances become soft and there is no hard substance between the heating device and the plurality of opposed rollers, it can be prevented that the surface of the heating device and opposed rollers is damaged. It is preferable that the conveyance device is driven after the temperature of the heating device reaches to a predetermined temperature and a predetermined time period has elapsed after that.

In accordance with another aspect of the present invention, a thermal developing apparatus comprises a heating device for heating a thermal developing film, a conveyance device for conveying the thermal developing film to be heated, a driving device for driving the conveyance device, a thermal developing device for heating and visualizing the thermal developing film on which a latent image is formed while conveyed, a cleaning device for cleaning a surface of the heating device while contacting the surface of the heating device, and the cleaning device moves away from the surface after cleaning, a temperature detecting device for detecting a temperature of the heating device and a controller for controlling the cleaning device so as to limit a cleaning operation until a detected temperature of the heating device reaches to a predetermined temperature.

According to the thermal developing apparatus, even thought organic acid and higher fatty acid volatized from a thermal developing film, as a film processing proceeds, cohere and adhere on cohesive substances of cutting dross from film edges and emulsion flakes which have adhered and cohered onto a heating device, since driving a cleaning device by a driving device is limited until the temperature of the heating device reaches to a predetermined temperature and the cleaning device is driven after the temperature of the heating device reaches to the predetermined temperature and the foreign substances become soft, it can be protected that the web and rollers of the cleaning device is damage by foreign matter when starting up the apparatus. Accordingly, even though cleaning is conducted within a warming up period, the cleaning device is not damaged. It is preferable that a cleaning device is operated after the temperature of a heating device reaches to a predetermined temperature and a predetermined time period elapsed.

In the thermal developing apparatus, since the controller controls the driving device to limit the drive until the detected temperature of a heating device reaches to a predetermined temperature, it is prevented that foreign matters give damages to the surface of a heating device, such as a heating drum, when starting up the apparatus.

Since the thermal developing device can be structured so that a plurality of opposed rollers push the thermal developing film toward the heating device, a conveyance device is driven after the temperature of the heating device reaches to a predetermined temperature and the foreign matters become soft, and there is no hard substance between the heating device and the plurality of opposed rollers, the surface of the heating device is prevented from being damaged.

It is preferable that a smooth surface is provided on the most outer layer of the heating device to improve a mold release against the foreign matters described above in the thermal developing apparatus.

According to the thermal developing apparatus of the present invention, it is prevented that the foreign substance which originated in the cutting dross from near thermal developing film edges and emulsion flakes adhering and solidifying on a heating device, and grew, gives damages the surface of heating device and the cleaning device, when a thermal developing process is conducted.

### BRIEF DESCRIPTION OF THE DRAWING

FIG. 1 is a front elevation showing a main portion of an embodiment of the present invention.

FIG. 2 is a perspective view of the thermal developing device viewing from a film exit side of the thermal developing apparatus shown in FIG. 1.

FIG. 3 is a schematic diagram of the exposing device of the thermal developing apparatus shown in FIG. 1.

FIG. 4 is a perspective view of thermal developing device 130 shown in FIG. 1.

FIG. 5 is a cross-sectional view of the structure of thermal developing device shown in FIG. 4 being viewed from the direction indicated by angled arrows IV-IV.

FIG. 6 is a front elevation of the structure shown in FIG. 4.

FIG. 7 is a plan view schematically showing opposed rollers arranged against the heating drum shown in FIG. 2 and the passing width of a film.

FIG. 8 is a schematic diagram showing the opposed roller shown in FIG. 7 is in contact with the surface of a heating drum.

FIG. 9 is a block diagram showing a control system for heating drum 14 shown in FIGS. 1-6 and cleaning device shown in FIG. 8.

FIG. 10 is a flowchart describing an operation of the thermal developing apparatus shown in FIGS. 1 6.

FIG. 11 another example of the cleaning device shown in FIGS. 7 and 8.

### DETAILED DESCRIPTION OF PREFERRED EMBODIMENT

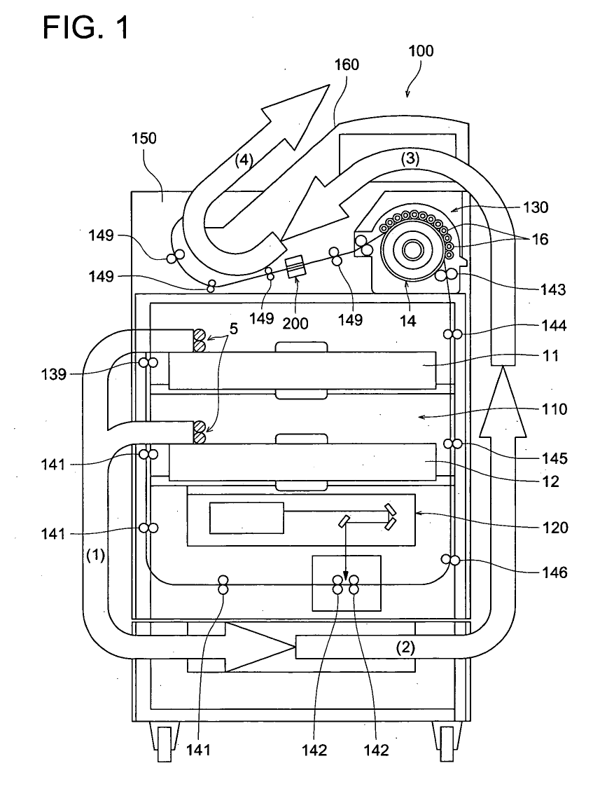

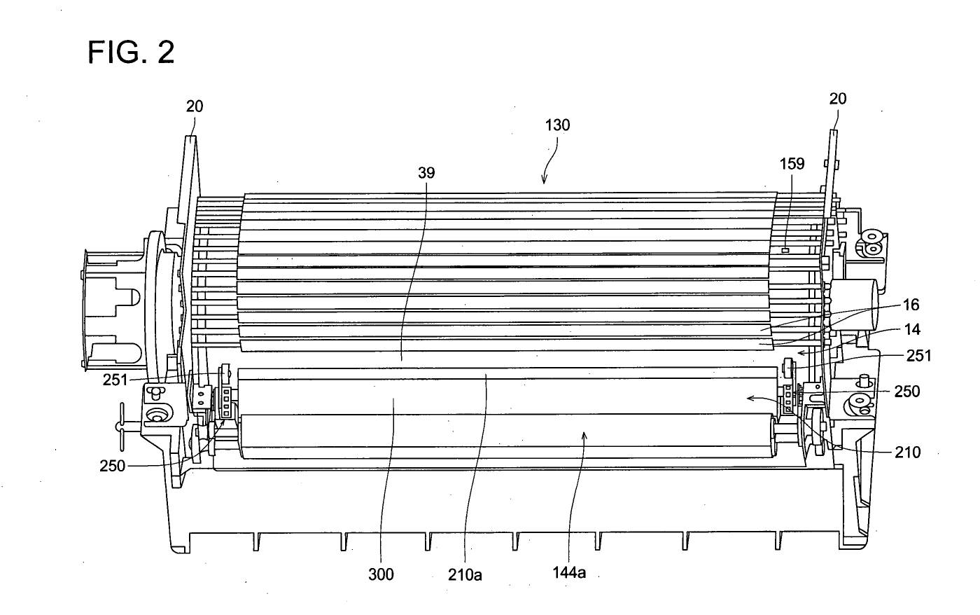

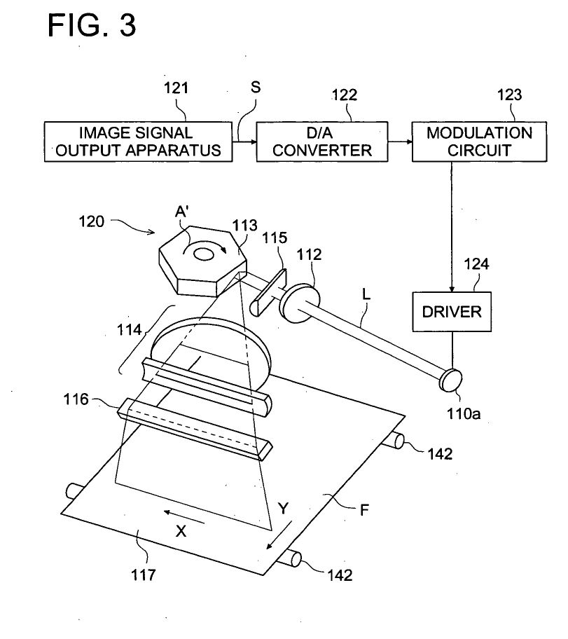

A preferred embodiment of the present invention will be described by using drawings below. FIG. 2 is a perspective view of a thermal developing apparatus shown in FIG. 1 being viewed form the exit side of a film. FIG. 3 is a schematic diagram of an exposing device of the thermal developing apparatus shown in FIG. 1.

Thermal developing apparatus 100 shown in FIG. 1 comprises first and second loader 11 and 12 in which packages of thermal developing films being packaged into one package with a predetermined number of the films are loaded, feeder 110 having conveyer 5 for conveying films which conveys one sheet of film at a time, exposing device 120 for exposing the film conveyed from feeder 110 and forming a latent image, thermal developing device 130 for thermally developing the formed latent image, density measuring device 200 for measuring the density of the developed film and cooling conveyer 150 including conveyer rollers 149, etc.

First loader 11 and second loader 12 of feeder 110 are capable of loading different sizes of films respectively. A film conveyed from first loader 11 or second loader 12 is conveyed via conveyer 5 by paired conveyance rollers 139 and 141 (first conveyer) in the direction (1) indicated by an arrow as shown in FIG. 1. The film conveyed in the direction (2) indicated by the arrow and a latent image is formed on the film by exposing device 120 while it is sub-scanned. Then the film is conveyed in the direction (3) indicated by the arrow by paired conveyance rollers 146, 145, 144 and 143 (second conveyer) and the latent image is visualized by thermal developing device 130. Further, the film is conveyed in the direction (4) indicated by the arrow and cooled by cooling conveyer 150. Then it is ejected from ejector 160.

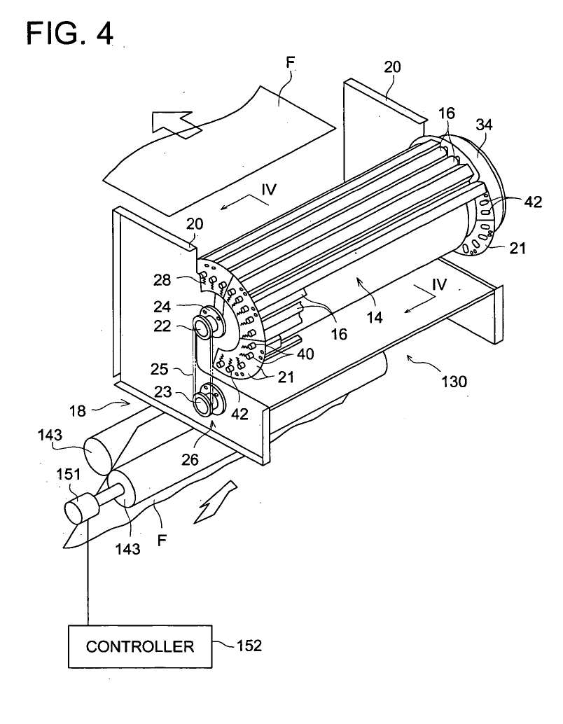

Paired conveyance rollers 139, 141, 142, 146, 145, 144 and 143 are driven by motors 151 and 156 being controlled by CPU (Central Processing Unit) in controller 152 as shown in FIGS. 4 and 13.

Exposing device 120 will be described below. Exposing device 120 forms a latent image onto film F by using laser beam L. As shown in FIG. 3, laser beam L modulated by image signal S (amplitude modulation) is reflected by polygon mirror 113 and irradiated onto film F for main scanning. Film F is simultaneously moved in the direction being substantially right angle with regard to the main scanning direction for sub-scanning. As a result, laser beam L forms latent image onto film F as described above.

The configuration of exposing device 120 will be described below. As shown in FIG. 3, image signal S being digital data outputted from external image signal output apparatus 121 is converted into analog signal by D/A converter 122 and inputted to modulation circuit 123. Modulation circuit 123 is arranged to control driver 124 of laser beam source 110a which radiate modulated laser beams.

Laser beam L radiated from laser beam source 110a is arranged to be guided on polygon mirror 113 rotated in the direction A′ shown in arrow in FIG. 3 as a line image being vertical to the driving shaft of polygon mirror 113 after passing through lens 112 and cylindrical lens 115 which converges laser beam L only in a up and down direction. Polygon mirror 113 polarizes laser beam L in the main scanning direction. Polarized laser beam L is reflected by mirror 116 provided in a laser beam path, which is prolonged in the main scanning direction, after passing via fθ lens 114 structured by two cylindrical lenses and repeatedly irradiated (main scanned in the direction X as shown by an arrow) onto film F conveyed by paired conveyance rollers 142 in the direction Y as shown in an arrow (sub-scanned). Namely, laser beam L is entirely irradiated onto the surface to be scanned 117 of film F.

The cylindrical lens of fθ lens 114 is arranged to converge incident laser beam L only in the sub-scanning direction onto surface to be scanned 117 of film F. The distance from fθ lens 114 to surface to be scanned 117 is arranged to be the focal distance of fθ lens 114. As described above, in exposing device 120, since fθ lens 114 including a cylindrical lens and mirror 116 are provided and further laser beam L is once converges on the surface of polygon mirror 113 in the sub-scanning direction, the scanning position on surface to be scanned 117 of film F does not shift even though surface deflection and/or shaft deflection occur/occurs, and as a result, constant pitch scanning can be conducted. Polygon mirror 113 has advantage that it is superior to a galvanometer mirror and an optical deflector in scanning stability. As described above, a latent image based on image signal S is formed onto film F.

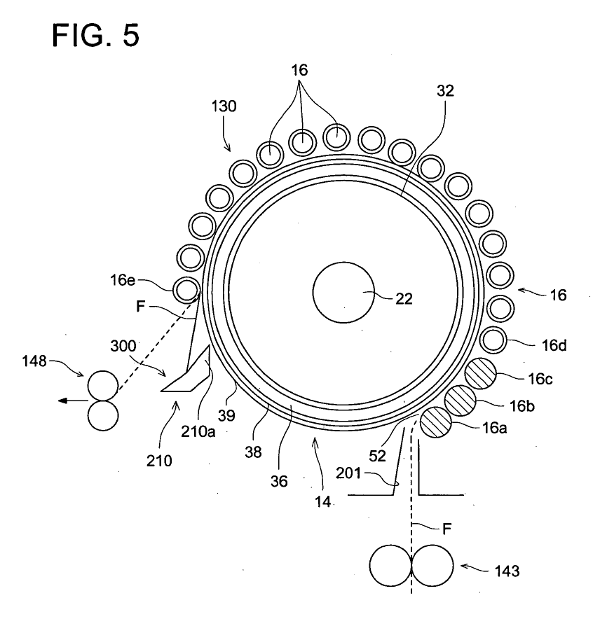

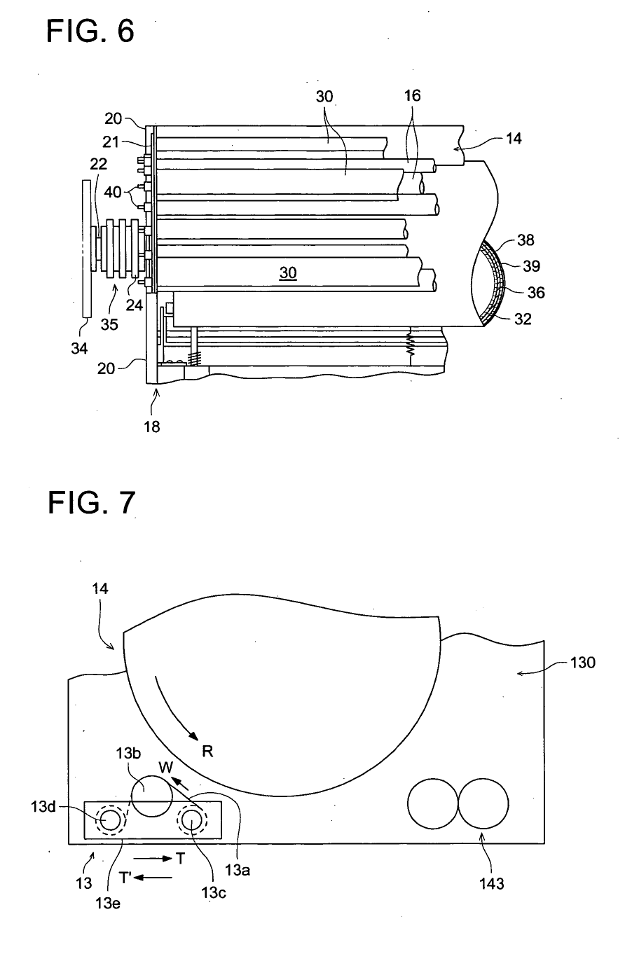

FIGS. 4-6 show a structural drawing of thermal developing device for heating film F. FIG. 4 is a perspective view of thermal developing device 130. FIG. 5 is a cross-sectional view of the structure of thermal developing device shown in FIG. 4 being viewed from the direction indicated by angled arrows IV-IV. FIG. 6 is a front elevation of the structure shown in FIG. 4.

Thermal developing device 130 has heating drum 14 as a heating member which heats film F while holding film F being in contact with the outer surface of heating drum 14 in thermal developing device 130. Heating drum 14 changes a latent image formed on film F into a visible image by heating and keeping film F at temperature more than minimum thermal developing temperature for a predetermined thermal developing time. The minimum thermal temperature is temperature at which the latent image formed on film F starts to be developed. For example, it is more than 95° C. Thermal developing time is time for which film F should be kept at temperature more than the minimum thermal developing in order to develop a latent image into a visible image having needed developing characteristic. Still, it is preferable that film F should not be thermally developed at less than 40° C.

As shown in FIGS. 4 and 5, there is provided a plurality of opposed rollers in the outside of heating drum 14 as a guide member and pressing member of film F, each of which has a smaller diameter than that of heating drum 14 and can be freely rotated. The opposed roller is provided parallel to the rotational axis of the shaft of heating drum 14 and opposed to the outer surface of heating drum 14.

Opposed roller 16 is structured by fully stuffed stainless steal. Opposed rollers 16a, 16b and 16c provide in the upper stream have a diameter of 12 mm being large diameter roller and the rest of opposed rollers, from 16d to 16e structured in a pipe shape having a diameter of 8 mm being a small diameter roller. It is preferable that the thermal capacity of opposed roller 16 is not less than 0.16 kJ/K and the thermal capacity of stainless steal being a material of opposed roller is about 0.18 kJ/K.

In both edges of heating drum 14, three guiding brackets 21 supported by flame 18 is provide in each side. Opposed “C” type shape is formed by combining guiding brackets 21 in the both ends of heating drum 14.

Guiding bracket 21 temporally holds a plurality of opposed rollers 16 at both ends of the opposed rollers 16. The holding position by brackets 21 is arranged to be adjustable. Namely, the relative position of a plurality of opposed rollers 16 against heating drum 16 can be adjusted by adjusting the position of guiding brackets 21. Accordingly, since the parallel accuracy between the axis direction of heating drum 14 and opposed rollers 16 can be adjusted, a film can uniformly contact the outer peripheral surface of heating drum 14. Particularly, as described later, when a smooth surface of fluorine resin is provided on the outer peripheral surface of heating drum 14, providing guiding bracket 21 capable of adjusting the parallel accuracy, even though the density unevenness is likely to occur, can prevent density unevenness.

Nine long holes 42 extended in a radial direction are provided each of guiding bracket 21. Shaft 40 provided in the end portion of opposed roller 16 is extended from long hole 40. One end of each coil spring 28 is attached to each shaft 40 and another end of each coil spring 28 is attached to the portion adjacent to the inner edge of guiding bracket 21. Accordingly, each opposed roller 16 is forced to the direction toward the outer peripheral of heating drum 16 based on the predetermined force of each coil spring 28. Film F is uniformly heated by being pressed toward the outer peripheral surface of heating drum 14 by the predetermined force when film F is inserted between heating drum 14 and opposed roller 16. As described above, opposed roller 16 forced toward heating drum 14 being rotated coveys a film while sandwiching the film with heating drum 14.

Shaft 22 coaxially connected to heating drum 14 extending toward the outer direction from end member 20 of flame 18 is freely supported by end member 20 via shaft bearing 24. A gear (not shown) is formed in rotary shaft 23 of micro-stepping motor (not shown) located under shaft 22 and attached to end member 20. Another gear is formed in shaft 22. Power of the micro-stepping motor is transmitted via timing belt 25 which connects both gears and rotates heating drum 14. It is also possible to transmit the power from rotary shaft 23 to shaft 22 via a chain and gear instead of timing belt 25.

As shown in FIGS. 4-6, heating drum 14 comprises cylindrical type aluminum sleeve 36 to be driven, heater 32 being a heating source stuck on the internal surface of sleeve 36, soft elastic layer 38 structured by silicon rubber which is attached on the outside of sleeve 36 and smooth layer 39 as a most outer layer formed into predetermined thickness being sintered at predetermined temperature after fluorine resin is deposited on the outer peripheral surface of sleeve 38.

Heating drum 14 is heated until the temperature of heating drum 14 reaches to a predetermined temperature by heater 32 which is controllably energized. Temperature sensor 159 for detecting the temperature of heating drum 14 is provided on a surface of smooth layer 39 of heating drum as shown in FIG. 2. A well-known thermoelectric pair or thermistor can structure temperature sensor 159.

The thickness of elastic layer 38 and thermal conductivity are selected so that a continuous process of a plurality of films F can be efficiently conducted. It is preferable that the thermal conductivity of elastic layer 38 is not less than 0.5 W/k. It is preferable that the hardness of elastic layer 38 is from 20 to 70 degree in Japanese Industry Standard (JIS)-A hardness. Elastic layer 38 may be indirectly attached on to sleeve 36.

Rubber or a rubber type member can structure elastic layer 38. As rubber or rubber type member, other than various rubber materials or thermoplastic elastomer, various materials having elasticity being the same as that of rubber member are widely available. For example, various rubber material, resin material and thermoplastic elastomer may be used as a single material or a mixed material. In this case, each rubber material is not limited and for example, other than solid rubber member, liquid type reaction hardening substance which can be obtained by hardening liquid type elastic substance may be used.

With regard to a solid rubber material, for example, ethylene-propylene-ternarycopllymer (EPDM), butyle rubber, polyisobutylene, ethylene-propylene rubber, chloroprene rubber, natural rubber, styrene-butadiene rubber, styrene-isoprene-styrene, styrene-butadiene-styrene or polyurethane rubber is singularly or compositely used with vulcanizing agent or combination agent such as cross linking agent, vulcanization accelerator, vulcanization accelerating auxiliary agent, tackifier, bulking agent, plasticizer, agent resistor or solvent being used in a general rubber industry is combined with a single and combination material of polymer.

Liquid type rubber material includes urethane, liquid state polybutadiene, degeneration silicon, silicon and polysulphide. It is preferable that these material described above is used after mixing a predetermined hardening agent and reaction-hardening. Elastic layer 38 may be formed into a solid state or a sponge state.

With regard to fluorine resin used for depositing for forming smooth layer 39, for example, chemical compound of polytetrafluoroethylene (PTFE), polychlorotrifluoroethylene (PCTFE), polyvinyliden fluoride (PVDF), copolymer of oethylene and perfluoroalkoxyethylene (ETFE), copolymer of tetrafluoroethylene and hexafluoropropylene (FEP) is used.

When film F placed around heating drum 14 is heated due to heating phenomenon, for example, gas containing chemical ingredient such as organic acid is generated. However, since fluorine resin which structures smooth layer 39 provided on the surface of elastic layer 38 has non-chemical reactivity, it does not react to gas ingredient such as organic acid. Accordingly, fluorine resin is not be deteriorated. Also, since fluorine resin shuts off the gas ingredient so that the gas ingredient does not contact elastic layer 38 structured by silicon rubber, etc., elastic layer 38 is not be deteriorated or degenerated by the gas ingredient. Accordingly, since the secular change of the shape and characteristic of elastic layer 38 seldom happens, initial elasticity and thermal conductivity can be maintained.

It is preferable that the thickness of smooth layer 39 is not less than 10 μm from the view point of preventing elastic layer 38 from deterioration by gas ingredient of organic acid, and not more than 60 μm from the view point of preventing density unevenness.

It is necessary to pay attention to the selection of the forced power of coil spring 28, since the force power of coil spring 28 is determined so that film F securely contacts the outer peripheral surface of heating drum 14 and is steadily conveyed while receiving enough thermal transmission. Namely, when forced power of coil spring 28 is small, it is anticipated that heat does not uniformly transmit onto film L and resulting incomplete image development and unsteady conveyance of film F.

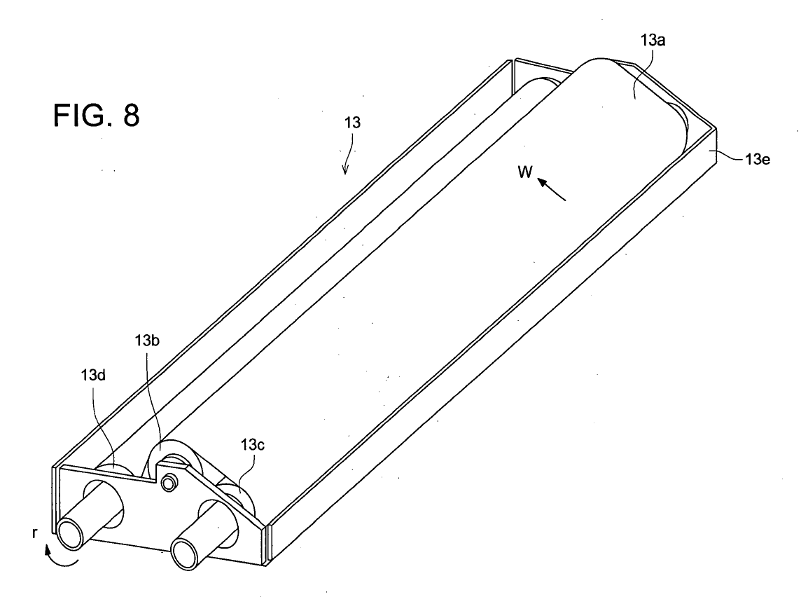

Cleaning device 13 provided in thermal developing apparatus shown in FIG. 1 will be described by using FIGS. 7-8. FIG. 7 is a front elevation magnifyably and partially showing a cleaning device and a heating drum. FIG. 8 shows a cleaning device provided in the thermal developing apparatus shown in FIG. 1.

Cleaning device 13 for cleaning the surface of heating drum 14 is provided under heating drum 14 in thermal developing device 130 of thermal developing apparatus 100. As shown in FIGS. 7-8, cleaning device 13 comprises cleaning web 13a having the same width as that of heating drum 14 in the longitudinal direction, pushing roller 13b for pressing cleaning web 13a, roll-out roller 13c for supplying cleaning web 13a being wound, roll-up roller 13d being driven for rolling in cleaning web 13a from pushing roller 13b and chassis 13e for housing rollers 13b-13d.

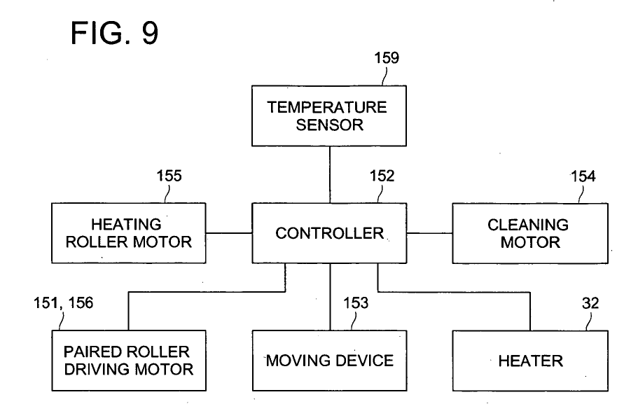

Cleaning device 13 is moved in the direction indicted by arrow T from a solid line position shown in FIG. 7 by moving device 153 shown in FIG. 9. Cleaning web 13a contacts the surface of heating drum 14 (the surface to which a film contact) and is pressed for tightly contacting the surface of heating drum 14 by pushing roller 13b for cleaning the surface of heating drum 13. After completing the cleaning, cleaning web 13a moves in the direction indicated by arrow T′ and moves away from the surface of heating drum 13. Still, moving device 153 is structured so that moving device 153 moves chassis 13e by a reciprocal mechanism having a motor, wire and a pulley in the directions T and T′, which is well known. However, it is not limited to the embodiment described above.

As described above, since cleaning device 13 firmly presses cleaning web 13a to the surface of heating drum 14 when cleaning and keeps away from it when non-cleaning, cleaning web does not increase load for heating drum 14 when rotating for heating film.

Cleaning web 13a is structured by a long sheet of nonwoven fabric absorber. Cleaning web 13a has thermal resistance for heat from heating drum 14 and chemical resistance for enduring organic acid and cohesion substance such as MEK and efficiently absorbs adhesion on the surface of heating drum 14 by contacting pressing roller.

When roll-up roller 13d is rotated in the rotation direction r as shown in FIG. 8 by cleaning motor 154 shown in FIG. 9, an unused portion of cleaning web 13a being stored in roll-out roller 13c is pulled out and contacted the surface of smooth surface layer 39 of heating drum 14 by pushing roller 13b. After finishing cleaning, cleaning web 13a is rolled up by roll-up roller 13d.

When cleaning heating drum 14, heating drum 14 rotates in the direction R so that the whole outer peripheral surface of heating drum 14 is cleaned. At that time, cleaning web 13a moves in the direction W as shown in FIG. 7. Namely, cleaning web 13a from roll-out roller 13c is rolled in by roll-in roller 13d while it is moved in the direction W and pressed onto the surface of smooth surface layer 39 of heating drum 14 for cleaning as shown in FIG. 7.

It may be also possible to contact a paused state cleaning web 13a to smooth surface layer 39 of heating drum 14 while heating drum 14 rotates in the direction R. In this case, it is preferable that after finishing the cleaning and cleaning device 13 moves away from heating roller 14 in the direction T′ indicated by an arrow in FIG. 7, roll-in roller 13d rolls up cleaning web 13a from roll-out roller 13c in order to position an unused portion of cleaning web 13a on the pushing roller 13b for being prepared for the next cleaning.

A control system for controlling heating drum 14 and cleaning device 13 will be described by using FIG. 9. FIG. 9 is a block diagram of the control system for controlling heating drum 14 shown in FIGS. 1-6 and cleaning device 13 shown in FIGS. 7 and 8.

Controller 152 shown in FIGS. 4 and 9 controls micro stepping motor 155 for heating roller 14 based on a detected temperature signal from temperature sensor 159 provided on heating drum 14, moving device 153 for moving cleaning device 13 and cleaning motor 154. Further controller 152 controls the temperature of heating drum 14 by controlling a power-on time of heater 32.

Controller 152 controls micro-stepping motor 155, moving device 153 of cleaning device 13 and cleaning motor 154 not to be driven when a detected temperature of heating drum detected by temperature sensor 159 is less than a predetermined temperature. Controller 152 controls micro-stepping motor 155, moving device 153 of cleaning device 13 and cleaning motor 154 to allow to be driven when the detected temperature of heating drum detected by temperature sensor 159 goes up to a temperature not less than the predetermined temperature. Also controller 152 can be arranged to control micro-stepping motor 155, moving device 153 of cleaning device 13 and cleaning motor 154 to allow to be driven when the detected temperature of heating drum 14 goes up to a temperature not less than the predetermined temperature and remains in the condition for a predetermined time period. The predetermined temperature and the predetermined time period can be set in controller 152.

Further, it is preferable that the predetermined temperature being a reference temperature of control with regard to the drive-control which is described above is set at temperature at which the foreign matters adhered on the surface of heating drum 14 and the surface of opposed roller 16 start to become soft. The foreign matters are generated as following. Cutting dregs and emulsion flakes from the edges of a film adheres and cohered on the surface of heating drum 14 and the surface of opposed rollers. The foreign matters are generated from organic acid and/or higher fatty acid volatized associated with a process of thermal developing film and cohered on the substance described above as cores. Further it is recommended that the condition of not less than predetermined temperature is kept for a predetermined time period. For example, when the detected temperature of heating drum 14 is kept not less than 80° C. for 5 minutes, emulsion flakes and cutting dross become soft.

A guide member for guiding film F moved away from heating drum 14 for the first time will be explained by using FIGS. 2 and 5. As shown in FIGS. 2 and 5, guide member 210 for separating and conveying developed film from heating drum 14 is provide under the most downstream of opposed roller 16e and between heating drum 14 and conveyance roller 148. Namely, guide member 210 is placed so that guiding surface 300 guides film F conveyed between heating drum 14 and opposed roller 16 and left smooth surface layer 39 arranged in the most outer peripheral surface of heating roller 14 in the first time. A member having adiabaticity such as non-woven fabric is provided in guiding surface 300.

As shown in FIG. 2, positioning device 250 for positioning guide member 210 with regard to heating drum 14 is provided on both edges of guide member 210. The distance between leading edge 210a of guide member 210 and heating drum 14 is kept constant by contacting rotary member 251 structured by a thrusting roller of positioning member 250 to heating roller 14 in both sides.

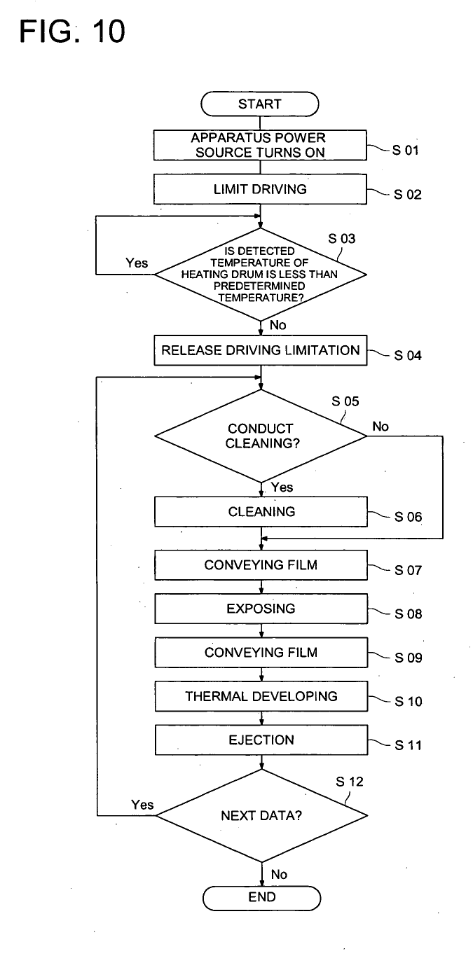

The operation of thermal developing apparatus 100 shown in FIGS. 1-9 will be described by using a flowchart shown in FIG. 10.

A power source of thermal developing apparatus 100 is turned on (S01). Then heater 32 of heating drum 14 is energized and the temperature rise of heating drum 14 starts. Controller 152 limits the driving of micro-stepping motor 155, moving device 153 of cleaning device 13 and cleaning motor 154 (S02).

Temperature sensor 159 detects the temperature of heating drum 14. Controller 152 shown in FIG. 9 determines whether the detected temperature is less than a predetermined temperature (S03), and remains in the same condition if the detected temperature of heating drum 14 is less than the predetermined temperature.

When the detected temperature of heating drum 14 rises not less than the predetermined temperature and a predetermined time period has passed, controller 152 stops limiting of driving of micro-stepping motor 155, moving device 153 of cleaning device 13 and cleaning motor 154 (S04). When cleaning device 13 cleans the surface of heating drum 14 (S05), controller 152 allows micro-step motor 155 to rotate heating drum 14, and moving device 153 to move in the direction of T as shown in FIG. 7. Then pushing roller 13b pushes cleaning web 13a toward the surface of heating roller 14 to clean the surface of heating drum 14 while motor 154 drives cleaning web 13a to move.

A film stored in first loader 11 or second loader 12 of feeder 110 is conveyed to exposing device 120 by conveyer 5, and paired conveyer rollers 139 and 141 (S07). When cleaning is not conducted in step S50, the process moves to step S70 right after the detected temperature of heating drum 14 has risen not less than the predetermined temperature and the predetermined time period has passed.

Then, the film is conveyed in the direction (2) as shown in an arrow and exposed by exposing device 120 based on image data while sub-scanned by paired conveyance rollers 142 (S08). As a result, a latent image is formed onto the film.

The film onto which the latent image is formed, is conveyed by paired conveyance rollers 146, 145, 144 and 143 to thermal developing device 130. In thermal developing device 130, the film is thermally developed while the film is pushed and tightly contacted against the outer surface of heating drum 14 by a plurality of opposed rollers 16 (S10). Rotating heating drum 14 driven by micro-step motor 155 conveys the film toward guiding member 210.

The film on which the latent image is visualized is conveyed in the direction shown in an arrow (4), cooled by cooling conveyer 150 and ejected by ejector 160 (S11). Further, when there is a following image data (S12), controller 152 moves the process to back to step S05 and repeats the same procedure.

As described above, according to thermal developing apparatus 100 shown in FIGS. 1-10, there is little risk of giving hitting marks (a concave shape) and scratches resulting in a damage to the surface of smooth layer 39 of heating drum 39 based on a following reasons.

In thermal developing apparatus 100, cutting dross and emulsion flakes from film edges adhere and cohere on the surfaces of heating drum 14 and/or opposed rollers 16 as thermal developing apparatus 100 is continuously operated. Even thought foreign matters grow from organic acid and/or higher fatty acid volatized as the process of thermal developing film proceeds, and cohered on the substance such as cutting dross and emulsion flakes described above as cores, since controller 152 limits the driving-controls of micro-step motor 154 of heating drum 14, moving device 153 of cleaning device 13 and cleaning motor 154 until the temperature of heating drum 14 reaches at a predetermined temperature and a predetermined time period has passed so that the driving control is released after the foreign matters become soft, there is little risk of giving hitting marks (a concave shape) and scratches resulting in damage to the surface of smooth layer 39 of heating drum 39. Accordingly, since the risk that hard foreign matters brake and give damages to cleaning web 13 can be eliminated.

Since heating drum 14 has smooth layer 39, release characteristic for the foreign matters on the surface of heating drum 14 can be enhanced and the foreign matters are easily removed.

The present invention is explained based on the embodiment described above. However the present invention is not limited to the embodiment. It may be changed and modified without departing from the scope of the present invention. For example, in FIG. 5, the number of opposed rollers having large thermal capacity located in the upstream side may be increased or decreased. The opposed rollers may be structured by a large diameter steal pipe shaped roller whose the thickness may be properly adjusted. The Material of the roller may be steel or aluminum other than stainless steal. The diameter of the opposed roller may be changed in three steps or more or rollers having different diameter may be arranged in turn.

In FIGS. 7-10, thermal developing apparatus 100 comprises cleaning device 13 with heating drum 14. However, cleaning device 13 may be eliminated. In this case, in FIG. 10, the process directly moves from step S04 to step S07.

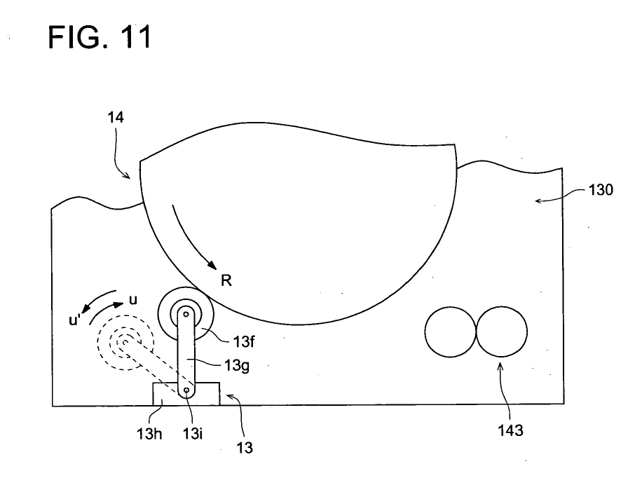

Further, cleaning device as shown in FIG. 11, may comprise a single cleaning roller. Namely, in cleaning device 13 shown in FIG. 11, cleaning roller 13f linked to arm 13g is arrange so as to swing with arm 13g in the directions u or u′ centering swing shaft 13i. Cleaning roller 13f swings in the direction u by the forced power device such as a coil (not shown). When cleaning roller 13f presses the surface of heating drum 14, it starts cleaning the surface of heating drum 14 while rotated by rotating heating drum 14. When non-cleaning, cleaning roller 13f is swung in the direction u′ by releasing the forced power by a releasing device (not shown) and moves away from the surface of heating drum 14. In FIG. 11, controller 152 shown in FIG. 9 controls a releasing device of cleaning roller 13f not to closely press cleaning roller 13f to the surface of heating roller 14. Accordingly, as described above, since cleaning roller 13f contacts the surface of heating drum 14 after foreign matters on the surface of heating drum 14 become soft, the risk that cleaning roller 13f gets damages is eliminated.

Further, it is apparent that a thermal developing apparatus is not limited to an apparatus having a heating drum and paired rollers as shown in this embodiment. The thermal developing apparatus, for example, may be a apparatus having a fixed plate having a plate heater therewith which heats a thermal developing film on the backside (not emulsion side) while the film is conveyed by a conveyance drum, or a plurality of opposed rollers which may have a smooth layer for release characteristic.

1. A thermal developing apparatus, comprising:
a thermal developing device for heating and visualizing a thermal developing film on which a latent image is formed while the thermal developing film is conveyed, the thermal developing device comprising:
a heating device for heating the thermal developing film;
a conveyance device for conveying the thermal developing film to be heated; and
a driving device for driving the conveyance device;
a temperature detecting device for detecting a temperature of the heating device; and
a controller for controlling the driving device so as to limit driving of the driving device until a detected temperature of the heating device reaches to a predetermined temperature.

2. The thermal developing apparatus of claim 1,
wherein the conveyance device comprises at least a roller for conveying the thermal developing film with the heating device.

3. A thermal developing apparatus, comprising:
a thermal developing device for heating and visualizing a thermal developing film on which a latent image is formed while the thermal developing film is conveyed, the thermal developing device comprising:
a heating device for heating the thermal developing film;
a conveyance device for conveying the thermal developing film to be heated; and
a driving device for driving the conveyance device;
a cleaning device for cleaning a surface of the heating device while the cleaning device is in contact with the surface of the heating device, and the cleaning device moves away from the surface after cleaning after cleaning;
a temperature detecting device for detecting a temperature of the heating device; and
a controller for controlling the cleaning device so as to limit a cleaning operation until a detected temperature of the heating device reaches to a predetermined temperature.

4. The thermal developing apparatus of claim 3,
wherein the controller limits the drive of the driving device until a detected temperature reaches to a predetermined temperature.

5. The thermal developing apparatus of claim 3, further comprising:
a plurality of opposed rollers for pushing the thermal developing film toward the heating device, the plurality of rollers being oppositely provided on the heating device.

6. The thermal developing apparatus of claim 4, further comprising:
a plurality of opposed rollers for pushing the thermal developing film toward the heating device, the plurality o rollers being oppositely provided on the heating device.

7. The thermal developing apparatus of claim 1,
wherein at least one of the heating device and the roller comprises a smooth layer on a most outer layer of the heating device.

8. The thermal developing apparatus of claim 3,
wherein at least one of the heating device and the roller comprises a smooth layer on a most outer layer of the heating device.
